(19) United States
(12) Patent Application Publication
(10) Pub. No.: US 2002/0144121 A1
(43) Pub. Date: Oct. 3, 2002

(54) Checking file integrity using signature generated in isolated execution

(76) Inventors: Carl M. Ellison, Portland, OR (US); Roger A. Golliver, Beaverton, OR (US); Howard C. Herbert, Phoenix, AZ (US); Derrick C. Lin, Foster City, CA (US); Francis X. McKeen, Portland, OR (US); Gilbert Neiger, Portland, OR (US); Ken Reneris, Wilbraham, MA (US); James A. Sutton, Portland, OR (US); Shreekant S. Thakkar, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/822,986

(22) Filed: Mar. 30, 2001

(51) Int. Cl. H04L 9/00

(52) U.S. Cl. 713/176

(57) ABSTRACT

A signature key is generated in a secure platform. The secure platform has a processor configured in one of a normal execution mode and an isolated execution mode. A file checker is loaded into an isolated memory area accessible to the processor in the isolated execution mode. In isolated execution mode, a file checker performs a scan operation on the original file and produces a result. A signature associated with the scanned file is generated based on the result and using the signature key. The signature indicates file integrity.

### BACKGROUND

1. Field

This invention relates to microprocessors. In particular, the invention relates to platform security.

2. General Background

Advances in microprocessor and communication technologies have opened up many opportunities for applications that go beyond the traditional ways of doing business. Electronic commerce (E-commerce) and business-to-business (B2B) transactions are now becoming popular, reaching the global markets at a fast rate. Unfortunately, while modern microprocessor systems provide users convenient and efficient methods of doing business, communicating and transacting, they are also vulnerable for unscrupulous attacks. Examples of these attacks include virus, intrusion, security breach, and tampering, to name a few. Computer security, therefore, is becoming more and more important to protect the integrity of the platforms and increase the trust of users.

Threats caused by unscrupulous attacks may occur in a number of forms. For instance, an invasive remote-launched attack by hackers may disrupt the normal operation of a system connected to thousands or even millions of users. A virus program may corrupt code and/or data operating on a single-user platform or may propagate itself to other platforms when connected to a network. Although anti-virus programs have been developed to scan, detect and eliminate known viruses, a large performance penalty would be incurred if an anti-virus program is required to examine every file before it can be opened.

### BRIEF DESCRIPTION OF THE DRAWINGS

The features and advantages of the present invention will become apparent from the following detailed description of the present invention in which:

FIG. 1A is an exemplary embodiment of an operating system in accordance with one embodiment of the invention.

FIG. 1B is an exemplary embodiment showing accessibility of various elements in the operating system and the processor in accordance with one embodiment of the invention.

FIG. 1C is an exemplary embodiment of a platform in which one embodiment of the invention can be practiced.

FIG. 2 is an exemplary embodiment of a file checking environment in accordance with one embodiment of the invention.

FIG. 3 is an exemplary embodiment of a process to access a file through signature and signatory verification in accordance with one embodiment of the invention.

### DESCRIPTION

The invention relates to a method and apparatus to check file integrity within the platform itself for protection against virus attacks or intrusion. Within the platform, the file is accessed based on a verified digital signature chain. The file is not opened, much less executed, if (1) no digital signature chain is associated with the file, (2) the digital signature chain is provided by an unauthorized signatory, or (3) the digital signature chain indicates an unacceptable file integrity upon verification. The file may be opened and subsequently executed if the verified digital signature chain indicates acceptable file integrity. The scan operation for creating the digital signature on a file is performed in an isolated execution mode. Verification of the digital signature chain (signature and its certificate chain) can be performed anywhere within the platform such as by the operating system. This operation can be cached to increase performance by any of a number of well known methods. By performing a signature operation within the platform itself and during the isolated execute mode, the time delay between file acquisition or creation and approval of the file for use is minimized.

Herein, terminology is used to discuss certain features of the present invention. For example, a “platform” may generally be considered as hardware equipment and/or software that process information. Some illustrative examples of a platform include a computer (e.g., desktop, a laptop, a hand-held, a server, a workstation, etc.), communication device (e.g., router, bridge, brouter, etc.), a wireless telephone handset, a television set-top box, and the like. A “file” is generally considered herein as a collection of information in a selected format. Various types of files include code (e.g., source, object, executable), applications, applets, operating systems, a digital document (e.g., word processing, spreadsheet, etc.), an electronic mail (e-mail) message and the like. “Information” includes data, address and/or control.

With respect to cryptography related terminology, a “key” is an encoding and/or decoding parameter. The term “signatory” is defined as a manufacturer, a trade association, a governmental entity, a bank, a particular department of a company (e.g., security or the information technology “IT” department) or any other entity or person in a position of trust. A “digital signature chain” includes an ordered sequence of digital signatures and/or certificates arranged for authorization purposes, where a certificate may be used to authenticate the authority of a signatory of a corresponding digital signature.

In the following description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention.

A. ARCHITECTURE OVERVIEW

One principle for providing security in a platform is the concept of an isolated execution architecture. The isolated execution architecture includes logical and physical definitions of hardware and software components that interact directly or indirectly with an operating system of the platform. An operating system and the processor may have several levels of hierarchy, referred to as rings, corresponding to various operational modes. A “ring” is a logical division of hardware and software components that are designed to perform dedicated tasks within the operating system. The division is typically based on the degree or level of privilege, namely, the ability to make changes to the platform. For example, a ring-0 is the innermost ring, being at the highest level of the hierarchy. Ring-0 encompasses the most critical, privileged components. In addition, modules in Ring-0 can also access to lesser privileged data, but not vice versa. Ring-3 is the outermost ring, being at the lowest level of the privilege. Ring-3 typically encompasses users or applications level and has the least privilege. Ring-1 and ring-2 represent the intermediate rings with decreasing levels of privilege.

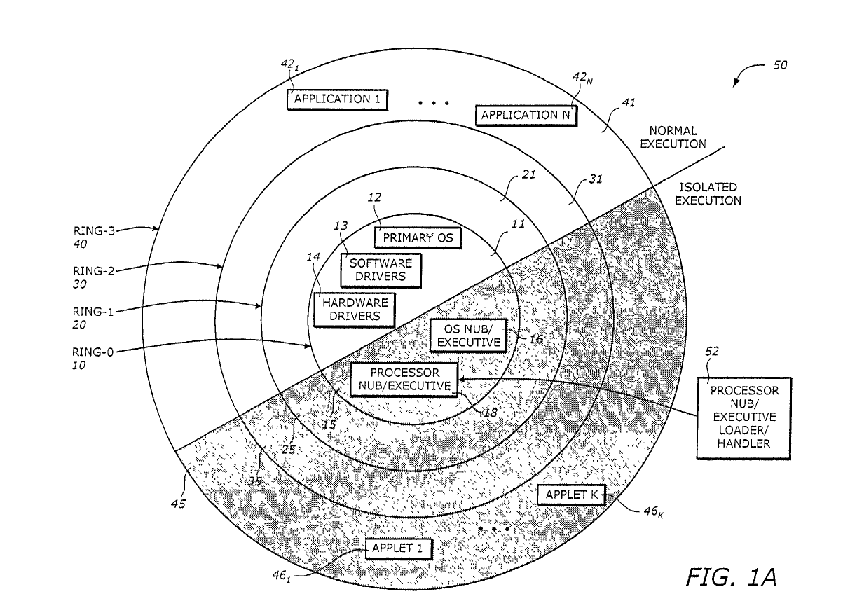

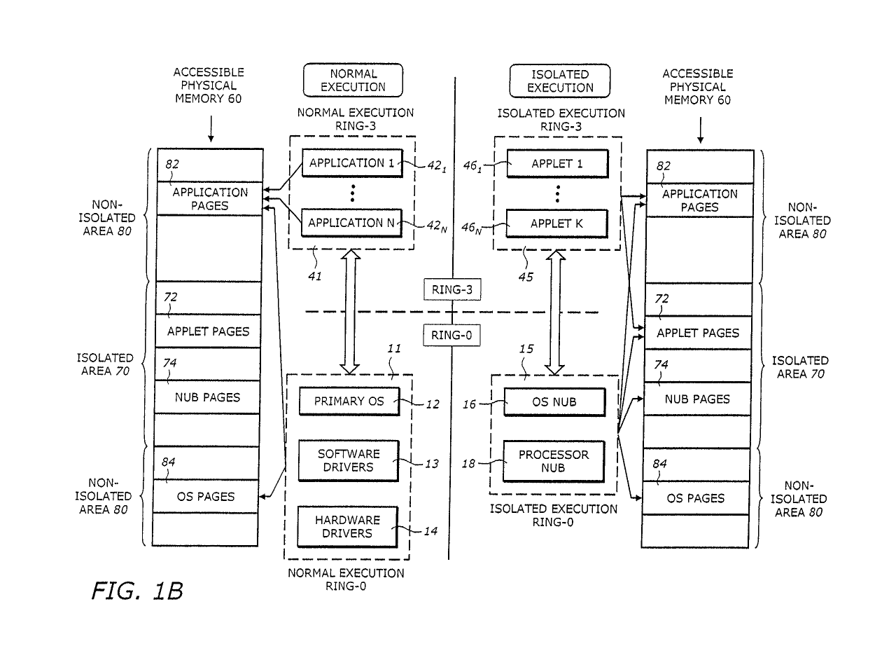

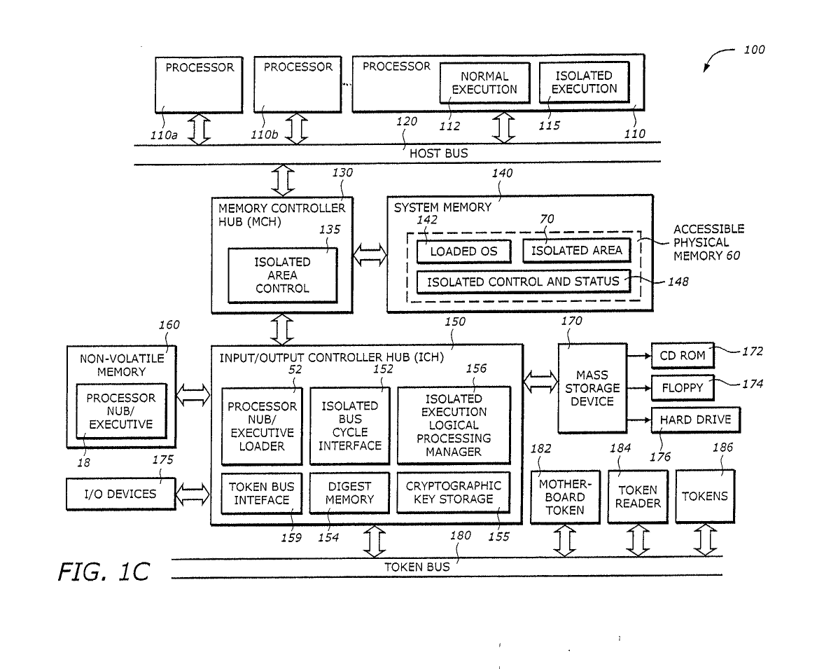

FIG. 1A is a diagram illustrating a logical operating architecture 50 according to one embodiment of the invention. The logical operating architecture 50 is an abstraction of the components of an operating system and the processor. The logical operating architecture 50 includes ring-0 10, ring-1 20, ring-2 30, ring-3 40, and a processor nub loader 52. The processor nub loader 52 is an instance of a processor executive (PE) handler. The PE handler is used to handle and/or manage a processor executive (PE) as will be discussed later. The logical operating architecture 50 has two modes of operation: normal execution mode and isolated execution mode. Each ring in the logical operating architecture 50 can operate in both modes. The processor nub loader 52 operates only in the isolated execution mode.

Ring-0 10 includes two portions: a normal execution Ring-0 11 and an isolated execution Ring-0 15. The normal execution Ring-0 11 includes software modules that are critical for the operating system, usually referred to as kernel. These software modules include primary operating system (e.g., kernel) 12, software drivers 13, and hardware drivers 14. The isolated execution Ring-0 15 includes an operating system (OS) nub 16 and a processor nub 18. The OS nub 16 and the processor nub 18 are instances of an OS executive (OSE) and processor executive (PE), respectively. The OSE and the PE are part of executive entities that operate in a secure environment associated with the isolated area (designated below) and the isolated execution mode. The processor nub loader 52 is a protected bootstrap loader code held within a chipset in the platform and is responsible for loading the processor nub 18 from the processor or chipset into an isolated area as will be explained later.

Similarly, ring-1 20, ring-2 30, and ring-3 40 include normal execution ring-1 21, ring-2 31, ring-3 41, and isolated execution ring-1 25, ring-2 35, and ring-3 45, respectively. In particular, normal execution ring-3 includes N files (e.g., applications 42₁ to 42_{N}) and isolated execution ring-3 includes K files (e.g., applets 46₁ to 46_{K}).

One concept of the isolated execution architecture is the creation of an isolated region in the platform memory, referred to as an isolated area, which is protected by the processor and/or chipset in the platform. The isolated region may also be in cache memory, protected by a translation look aside (TLB) access check. Access to this isolated region is permitted only from a front side bus (FSB) of the processor, using special bus (e.g., memory read and write) cycles, referred to as isolated read and write cycles. The special bus cycles are also used for snooping. The isolated read and write cycles are issued by the processor executing in an isolated execution mode. The isolated execution mode is initialized using a privileged instruction in the processor, combined with the processor nub loader 52. The processor nub loader 52 verifies and loads a ring-0 nub software module (e.g., processor nub 18) into the isolated area. The processor nub 18 provides hardware-related services for the isolated execution.

One task of the processor nub 18 is to verify and load the ring-0 OS nub 16 into the isolated area, and to generate the root of a key hierarchy unique to a combination of the platform, the processor nub 18, and the operating system nub 16. The operating system nub 16 provides links to services in the primary OS 12 (e.g., the unprotected segments of the operating system), provides page management within the isolated area, and has the responsibility for loading ring-3 application modules 45, including applets 46₁ to 46_{K}, into protected pages allocated in the isolated area. The operating system nub 16 may also load ring-0 supporting modules.

The operating system nub 16 may choose to support paging of data between the isolated area and ordinary (e.g., non-isolated) memory. If so, then the operating system nub 16 is also responsible for encrypting and hashing the isolated area pages before evicting the page to the ordinary memory, and for checking the page contents upon restoration of the page. The isolated mode applets 46₁ to 46_{K} and their data are tamper-resistant and monitor-resistant from all software attacks from other applets, as well as from non-isolated-space applications (e.g., 42₁ to 42_{N}), dynamic link libraries (DLLs), drivers and even the primary operating system 12. Only the processor nub 18 or the operating system nub 16 can interfere with or monitor the applet's execution.

FIG. 1B is a diagram illustrating accessibility of various elements in the operating system 10 and the processor according to one embodiment of the invention. For illustration purposes, only elements of ring-0 10 and ring-3 40 are shown. The various elements in the logical operating architecture 50 access an accessible physical memory 60 according to their ring hierarchy and the execution mode.

The accessible physical memory 60 includes an isolated area 70 and a non-isolated area 80. The isolated area 70 includes applet pages 72, nub pages 74 and a file checker 75. The non-isolated area 80 includes application pages 82 and operating system pages 84. The isolated area 70 is accessible only to elements of the operating system and processor operating in isolated execution mode. The non-isolated area 80 is accessible to all elements of the ring-0 operating system and to the processor.

The normal execution ring-0 11 including the primary OS 12, the software drivers 13, and the hardware drivers 14, can access both the OS pages 84 and the application pages 82. The normal execution ring-3, including applications 42₁ to 42_{N}, can access only to the application pages 82. Both the normal execution ring-0 11 and ring-3 41, however, cannot access the isolated area 70.

The isolated execution ring-0 15, including the OS nub 16 and the processor nub 18, can access to both of the isolated area 70, including the applet pages 72 and the nub pages 74, and the non-isolated area 80, including the application pages 82 and the OS pages 84. The isolated execution ring-3 45, including applets 46₁ to 46_{K}, can access only to the application pages 82 and the applet pages 72. The applets 46₁ to 46_{K} reside in the isolated area 70.

FIG. 1C is a diagram illustrating a platform 100 in which one embodiment of the invention can be practiced. The platform 100 includes a processor 110, a host bus 120, a memory controller hub (MCH) 130, a platform memory 140, an input/output controller hub (ICH) 150, a non-volatile memory 160, a mass storage device 170, input/output devices 175, a token bus 180, a motherboard (MB) token 182, a reader 184, and a token 186. The MCH 130 may be integrated into a chipset that integrates multiple functionalities such as the isolated execution mode, host-to-peripheral bus interface, memory control. Similarly, the ICH 150 may also be integrated into a chipset together or separate from the MCH 130 to perform I/O functions. For clarity, not all the peripheral buses are shown. It is contemplated that the platform 100 may also include peripheral buses such as Peripheral Component Interconnect (PCI), accelerated graphics port (AGP), Industry Standard Architecture (ISA) bus, and Universal Serial Bus (USB), etc.

The processor 110 represents a central processing unit of any type of architecture, such as complex instruction set computers (CISC), reduced instruction set computers (RISC), very long instruction word (VLIW), or hybrid architecture. In one embodiment, the processor 110 is compatible with an Intel Architecture (IA) processor, such as the Pentium™ series, the IA-32™ and the IA-64™. The processor 110 includes a normal execution mode 112 and an isolated execution circuit 115. The normal execution mode 112 is the mode in which the processor 110 operates in a non-secure environment, or a normal environment without the security features provided by the isolated execution mode. The isolated execution circuit 115 provides a mechanism to allow the processor 110 to operate in an isolated execution mode. The isolated execution circuit 115 provides hardware and software support for the isolated execution mode. This support includes configuration for isolated execution, definition of an isolated area, definition (e.g., decoding and execution) of isolated instructions, generation of isolated access bus cycles, and generation of isolated mode interrupts.

In one embodiment, the platform 100 can be a single processor system, such as a desktop computer, which has only one main central processing unit, e.g. processor 110. In other embodiments, the platform 100 can include multiple processors such as processor 110 and processor(s) 110a and/or 110b, which are represented as optional by dashed lines in FIG. 1C. Thus, the platform 100 can be a multi-processor platform having any number of processors. For example, the multi-processor platform 100 can operate as part of a server or workstation environment. The basic description and operation of processor 110 will be discussed in detail below. It will be appreciated by those skilled in the art that the basic description and operation of processor 110 applies to the other processors 110a and 110b, shown in FIG. 1C, as well as any number of other processors that may be utilized in the multi-processor platform 100 according to one embodiment of the present invention.

The processor 110 may also have multiple logical processors. A logical processor, sometimes referred to as a thread, is a functional unit within a physical processor having an architectural state and physical resources allocated according to some partitioning policy. A multi-threaded processor is a processor having multiple threads or multiple logical processors. A multi-processor platform may feature multiple, multi-threaded processors.

The host bus 120 provides interface signals to allow the processor 110 and/or 110a, 110b to communicate with other processors or devices, e.g., the MCH 130. In addition to normal mode, the host bus 120 provides an isolated access bus mode with corresponding interface signals for memory read and write cycles when the processor 110 is configured in the isolated execution mode. The isolated access bus mode is asserted on memory accesses initiated while the processor 110 is in the isolated execution mode. The isolated access bus mode is also asserted on instruction pre-fetch and cache write-back cycles if the address is within the isolated area address range and the processor 110 is initialized in the isolated execution mode. The processor 110 responds to snoop cycles to a cached address within the isolated area address range if the isolated access bus cycle is asserted and the processor 110 is initialized into the isolated execution mode.

The MCH 130 provides control and configuration of memory and input/output devices such as the platform memory 140 and the ICH 150. The MCH 130 provides interface circuits to recognize and service isolated access assertions on memory reference bus cycles, including isolated memory read and write cycles. In addition, the MCH 130 has memory range registers (e.g., base and length registers) to represent the isolated area in the platform memory 140. Once configured, the MCH 130 aborts any access to the isolated area that does not have the isolated access bus mode asserted.

The platform memory 140 stores code and data. The platform memory 140 is typically implemented with dynamic random access memory (DRAM) or static random access memory (SRAM). The platform memory 140 includes the accessible physical memory 60 (shown in FIG. 1B). The accessible physical memory includes a loaded operating system 142, the isolated area 70 (shown in FIG. 1B), and an isolated control and status space 148. The loaded operating system 142 is the portion of the operating system that is loaded into the platform memory 140. The loaded OS 142 is typically loaded from a mass storage device via some boot code in a boot storage such as a boot read only memory (ROM). The isolated area 70, as shown in FIG. 1B, is the memory area that is defined by the processor 110 when operating in the isolated execution mode. Access to the isolated area 70 is restricted and is enforced by the processor 110 and/or the MCH 130 or other chipset that integrates the isolated area functionalities. The isolated control and status space 148 is an input/output (I/O)-like, independent address space defined by the processor 110 and/or the MCH 130. The isolated control and status space 148 contains mainly the isolated execution control and status registers. The isolated control and status space 148 does not overlap any existing address space and is accessed using the isolated bus cycles. The platform memory 140 may also include other programs or data which are not shown.

The ICH 150 represents a known single point in the platform having the isolated execution functionality. For clarity, only one ICH 150 is shown. The platform 100 may have many ICH's similar to the ICH 150. When there are multiple ICH's, a designated ICH is selected to control the isolated area configuration and status. In one embodiment, this selection is performed by an external strapping pin. As is known by one skilled in the art, other methods of selecting can be used, including using programmable configuring registers. The ICH 150 has a number of functionalities that are designed to support the isolated execution mode in addition to the traditional I/O functions. In particular, the ICH 150 includes an isolated bus cycle interface 152, the processor nub loader 52 (shown in FIG. 1A), a digest memory 154, a cryptographic key storage 155, an isolated execution logical processor manager 156, and a token bus interface 159.

The isolated bus cycle interface 152 includes circuitry to interface to the isolated bus cycle signals to recognize and service isolated bus cycles, such as the isolated read and write bus cycles. The processor nub loader 52, as shown in FIG. 1A, includes a processor nub loader code and its digest (e.g., hash) value. The processor nub loader 52 is invoked by execution of an appropriate isolated instruction (e.g., Iso_Init) and is transferred to the isolated area 70. From the isolated area 80, the processor nub loader 52 copies the processor nub 18 from the non-volatile memory 160 (e.g., the processor nub code 18 in non-volatile memory 160) into the isolated area 70, verifies and logs its integrity, and manages a symmetric key used to protect the processor nub's secrets. In one embodiment, the processor nub loader 52 is implemented in read only memory (ROM). For security purposes, the processor nub loader 52 is unchanging, tamper-resistant and non-substitutable. The digest memory 154, typically implemented in RAM, stores the digest (e.g., hash) values of the loaded processor nub 18, the operating system nub 16, and any other critical modules (e.g., ring-0 modules) loaded into the isolated execution space. The cryptographic key storage 155 holds a symmetric encryption/decryption key that is unique for the platform 100. In one embodiment, the cryptographic key storage 155 includes internal fuses that are programmed at manufacturing. Alternatively, the cryptographic key storage 155 may also be created with a random number generator and a strap of a pin. The isolated execution logical processor manager 156 manages the operation of logical processors operating in isolated execution mode. In one embodiment, the isolated execution logical processor manager 156 includes a logical processor count register that tracks the number of logical processors participating in the isolated execution mode. The token bus interface 159 interfaces to the token bus 180. A combination of the processor nub loader digest, the processor nub digest, the operating system nub digest, and optionally additional digests, represents the overall isolated execution digest, referred to as isolated digest. The isolated digest is a fingerprint identifying the ring-0 code controlling the isolated execution configuration and operation. The isolated digest is used to attest or prove the state of the current isolated execution.

The non-volatile memory 160 stores non-volatile information. Typically, the nonvolatile memory 160 is implemented in flash memory. The non-volatile memory 160 includes the processor nub 18. The processor nub 18 provides the initial set-up and low-level management of the isolated area 70 (in the platform memory 140), including verification, loading, and logging of the operating system nub 16, and the management of the symmetric key used to protect the operating system nub's secrets. The processor nub 18 may also provide application programming interface (API) abstractions to low-level security services provided by other hardware. The processor nub 18 may also be distributed by the original equipment manufacturer (OEM) or operating system vendor (OSV) via a boot disk.

The mass storage device 170 stores archive files such as code (e.g., processor nub 18), programs, data, applications (e.g., applications 42₁ to 42_{N}), applets (e.g., applets 46₁ to 46_{K}) and operating systems. The mass storage device 170 may include compact disk (CD) ROM 172, floppy diskettes 174, and hard drive 176, and any other magnetic or optical storage devices. The mass storage device 170 provides a mechanism to read machine-readable media. When implemented in software, the elements of the present invention are the code segments to perform the necessary tasks. The program or code segments can be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable programmable ROM (EPROM), a floppy diskette, a compact disk CD-ROM, an optical disk, a hard disk, a fiber optical medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, an Intranet, etc.

I/O devices 175 may include any /O devices to perform I/O functions. Examples of I/O devices 175 include a controller for input devices (e.g., keyboard, mouse, trackball, pointing device), media card (e.g., audio, video, graphics), a network card, and any other peripheral controllers.

The token bus 180 provides an interface between the ICH 150 and various tokens in the platform. A token is a device that performs dedicated input/output functions with security functionalities. A token has characteristics similar to a smart card, including at least one reserved-purpose public/private key pair and the ability to sign data with the private key. Examples of tokens connected to the token bus 180 include a motherboard token 182, a token reader 184, and other portable tokens 186 (e.g., smart card). The token bus interface 159 in the ICH 150 connects through the token bus 180 to the ICH 150 and ensures that when commanded to prove the state of the isolated execution, the corresponding token (e.g., the motherboard token 182, the token 186) signs only valid isolated digest information. For purposes of security, the token should be connected to the digest memory.

B. SCAN OPERATIONS IN ISOLATED EXECUTION MODE

The platform operates in accordance with a policy for checking file integrity against virus(es) or intrusion. Thus, an unknown file is not opened unless its file integrity is verified. An unknown file is a file that has just been created (e.g., a new file having no digital signature chain associated therewith or is currently inoperative (e.g., the file requires verification of its digital signature chain before it can be opened). By refusing to open files with a digital signature chain indicating unacceptable file integrity or without the digital signature chain, the platform can be guaranteed that there will be no opportunities for a virus to spread, infecting the platform or other platforms in communications therewith.

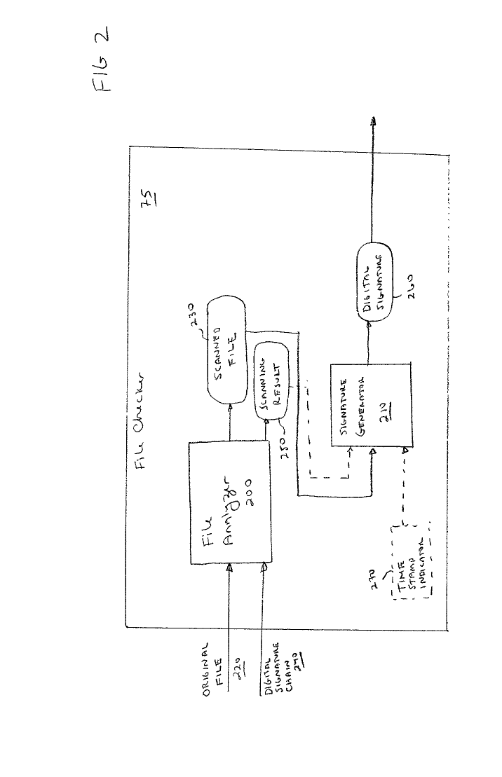

Referring to FIG. 2, employed within the isolated area 70 of the platform memory 140, the file checker 75 checks file integrity of files in a platform. The file checker 75 comprises a file analyzer 200 and a signature generator 210. The file analyzer 200 receives an original file 220 and produces a scanned file 230. The scanned file 230 is the original file 220 after performance of one or more scan operations.

In particular, the file analyzer 200 is a facility to perform one or more scan operations on the original file 220 and return the scanned file 230. Examples of scan operations include, but are not limited or restricted to a virus detection, an intrusion detection, a file integrity detection, or any appropriate detection function. Each scan operation may be performed by a commercial program or a proprietary program. For instance, file integrity detection may be accomplished by analyzing the contents of a digital signature chain 240, corresponding to the original file 220, to recover a scanning result 250. The scanning result 250 may indicate that the original file 220 has an acceptable file integrity (e.g., virus free), an unacceptable file integrity (e.g., infected with virus), or a questionable integrity which may require in-person analysis of the file. Alternatively, file integrity detection may be accomplished by comparing a digest resulting from hashing the original file 220 to a digest recovered from of a digital signature of the digital signature chain 240.

The signature generator 210 receives the scanned file 230 and optionally the scanning result 250 (represented by dashed lines). Thereafter, the signature generator 210 produces the digital signature 260. The digital signature 260 may be part of the digital signature chain 240 as described above.

It is further contemplated that the file checker 75 is optionally implemented with a time stamp indicator 270. The time stamp indicator 270 provides information regarding the recentness of the scan operation. In one embodiment, the time stamp indicator 270 is one of a calendar time obtained from the platform.

It is further contemplated that the file checker 75 may be optionally implemented with a mechanism for providing information regarding a version number of the file analyzer 200. For example, one mechanism is to place the version number into the digital signature chain 240 (e.g., into a signature or certificate of the chain 240). Another mechanism is for the developer of the file analyzer 200 to use different public/private signatory keys for different versions of the file analyzer 200. Thus, the version of the file analyzer 200 may be determined by review of its public signatory key and some versions may be enabled to sign files for a particular computer while other versions are not so enabled. Yet another mechanism involves the developer of the file analyzer 200 to issue multiple certificates having different, varying expiration dates (e.g., a selected time period such as a day, week or month) or even a non-expiring certificate. This would enable the user to select the time frame that would require the platform to update its file analyzer 200, and thus, the user, by selecting which certificates to empower (each certificate deriving its power from a different root key), can specify how old an analyzer he or she is willing to trust to scan files on the user's computer.

C. FILE ANALYSIS TO DETERMINE ACCESSIBILITY OF THE FILE

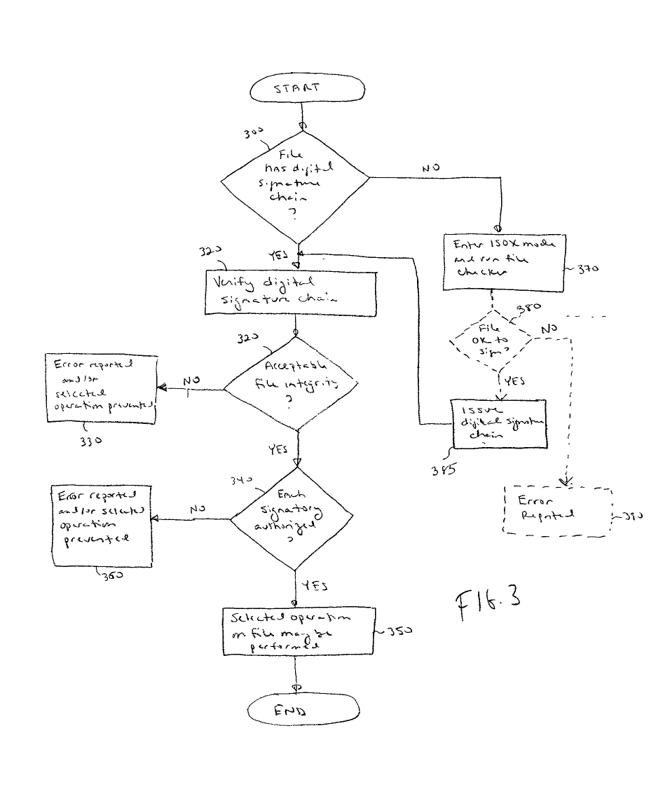

FIG. 3 is a flowchart illustrating a process for internal file checking according to one embodiment of the invention. Initially, in response to an event signaling a selected operation to a file (e.g., opening a file), a determination is made whether the file has a corresponding digital signature chain (block 300). In the situation that the digital signature chain is present, the digital signature chain is verified (block 310). This verification process may include recovering contents from a digital signature chain that indicate whether the file possesses an acceptable file integrity. Alternatively, the verification process may include comparison of a digest of the file recovered from the digital signature chain and a digest of the file produced.

After signature verification, if a determination is made that the file does not have an acceptable file integrity, an error is reported and/or the selected operation is prevented (blocks 320 and 330). Otherwise, a determination is made whether the signatory of each digital signature within a digital signature chain is authorized for signing files operated on by the platform (block 330). If the signatory is authorized, the selected operation is performed on the file within the platform (block 340). If the signatory is not authorized, an error may be reported and/or the selected operation is prevented (block 350).

In the situation where the digital signature chain is not present, the platform begins operation in the isolated execution (ISOX) mode and runs the file checker, which stored in access restricted memory (e.g., the isolated area of platform memory) as shown in block 370. The file checker analyzes the file and provides a signature that indicates the integrity of the file (block 385). Alternatively and optionally, as represented by dashed lines, the file checker may provide a signature only if the file integrity is acceptable or otherwise reports an error (blocks 380, 385, 390). Thereafter, the signature and signatory verification processes are conducted as shown in blocks 320 to 360.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A platform comprising:
a processor; and
a memory coupled to the processor, the memory including an isolated memory area containing a file checker executable by the processor, the file checker including (i) a file analyzer to perform a scan operation on a file to produce a scanning result and (ii) a signature generator to produce a digital signature chain including a digital signature having the scanning result.

2. The platform of claim 1, wherein the scan operation by the file checker is a virus detection function.

3. The platform of claim 1 wherein the incoming file is prevented from being executed if the verified digital signature chain indicated an unacceptable file integrity.

4. The platform of claim 1, wherein the incoming file is accessed if the verified digital signature chain indicates acceptable file integrity.

5. The platform of claim 1 further comprising a first control unit coupled to both the processor and the memory.

6. The platform of claim 5 further comprising a second control unit coupled to the first control unit and a token bus interface.

7. The platform of claim 6 further comprising a non-volatile memory coupled to the second control unit.

8. The platform of claim 6 further comprising input/output devices coupled to the second control unit.

9. The platform of claim 2 wherein the file analyzer is one of a virus detector, an intrusion detector, and a file integrity checker.

10. The platform of claim 1 wherein the signature generator comprises:
an encryptor to encrypt the scanning result using a signature key; and
a time stamper coupled to the encryptor to time stamp the encrypted result using a time indicator, the time stamped encrypted result corresponding to the digital signature.

11. The apparatus of claim 10 wherein the time indicator is one of a calendar time and a version identifier of the scanner.

12. The apparatus of claim 1 wherein the file is code.

13. A method comprising:
determining whether a digital signature chain accompanies a file to be accessed; and
verifying the digital signature chain of the file by determining (i) whether the file has an acceptable file integrity, and (ii) whether each signatory providing the digital signature chain is authorized.

14. The method of claim 13 further comprising:
precluding access to the file if the file has an unacceptable file integrity.

15. The method of claim 14 further comprising:
precluding access to the file if at least one signatory of the digital signature chain is unauthorized.

16. The method of claim 13, wherein prior to verifying the digital signature chain, the method further comprising:
entering into isolated execution mode if the file does not have a corresponding digital signature chain;
analyzing an integrity of the file; and
issuing the digital signature chain if the file has an acceptable file integrity.

17. The method of claim 16 further comprising:
issuing the digital signature chain with an indication that the file integrity is unacceptable if the integrity of the file is analyzed and determined to be unacceptable.

18. The method of claim 13 further comprising:
opening the file if the verified digital signature chain indicates an acceptable file integrity; and
refusing to open the file if the verified digital signature chain indicates an unacceptable file integrity.

19. A computer program embodied in a processor readable medium and executable by a processing unit, comprising:
code for determining whether a digital signature chain accompanies a file to be accessed; and
code for verifying the digital signature chain of the file by determining (i) whether the file has an acceptable file integrity, and (ii) whether each signatory providing the digital signature chain is authorized.

20. The method of claim 19 further comprising:
code for precluding access to the file if the file has an unacceptable file integrity.

21. The method of claim 19 further comprising:
code for precluding access to the file if at least one signatory of the digital signature chain is unauthorized.
